(19) United States
(12) Patent Application Publication
(10) Pub. No.: US 2025/0196810 A1
(43) Pub. Date: Jun. 19, 2025

(54) WIPER ARM OF WINDSHIELD WIPER AND WINDSHIELD WIPER

(71) Applicant: Robert Bosch GmbH, Stuttgart (DE)

(72) Inventor: Andreja Tosevski, Smederevo (RS)

(21) Appl. No.: 18/958,179

(22) Filed: Nov. 25, 2024

(30) Foreign Application Priority Data
Dec. 18, 2023 (DE) 10 2023 212 891.8

(51) Int. Cl. B60S 1/34

(52) U.S. Cl. CPC B60S 1/3415

(57) ABSTRACT

A wiper arm for a windshield wiper includes a wiper arm body having a mounting area for a hose connector element, and a hose connector element having a fluid inlet and a fluid outlet. The wiper arm body is configured to connect to a drive, and the hose connector element is configured to connect to a fluid supply system via the fluid inlet and the fluid outlet to transport fluid, and is attached to the mounting area of the wiper arm body in a torsion-resistant manner by way of a snap-fit connection.

### BACKGROUND

The present invention relates to a wiper arm of a windshield wiper and a windshield wiper having at least one such wiper arm.

Windshield wipers for vehicles are known from the prior art that comprise fluid lines on respective wiper arms of the windshield wiper to transport a wiper fluid of a fluid supply system of the vehicles to one or more nozzles on the wiper arms and/or on wiper blades arranged on the wiper arms to enable particularly targeted and fluid-saving wetting of a surface to be cleaned using the windshield wiper.

For this purpose, a hose connector element is generally provided in the area of the wiper arm, via which a hose incoming from the fluid supply system is connected to a hose leading to the at least one nozzle so that fluid can be transported via the hoses and the hose connector element.

In the prior art, the hose connector element is mounted on the wiper arm by means of locking pins, which are also referred to as “snap-fit-pins” and which in a mounted state engage through holes provided in the wiper arm.

### SUMMARY

According to a first aspect of the present invention, a wiper arm of a windshield wiper is proposed, wherein the windshield wiper is in particular a windshield wiper for a vehicle configured as, for example, a road vehicle (e.g., a motor vehicle, a passenger vehicle, a van, a truck) or a rail vehicle. For example, the windshield wiper is a windshield wiper for a pane of glass (e.g., a front windshield, a rear windshield) and/or for a lighting device (e.g., a headlight) and/or a protective pane of a sensor (e.g., a lidar, radar, an ultrasonic sensor, a camera, etc.) and/or any other surface of the vehicle to be cleaned and/or a device to be cleaned.

The wiper arm according to the present invention comprises a wiper arm body having a mounting area for a hose connector element and such a hose connector element having a fluid inlet and a fluid outlet, wherein the wiper arm body is configured to connect with a drive (e.g., an electric motor), and wherein the hose connector element is configured to connect with a fluid supply system via the fluid inlet and the fluid outlet in such a way that it can transport fluid, and which is attached to the mounting area of the wiper arm body in a torsion-resistant manner via a snap-fit connection, which can be reversible or irreversible.

The hose connector element can in principle have any external shape and can, for example, be substantially cuboid, cylindrical or formed in some other manner.

It should be noted that a number of locking elements, which realize a respective snap-fit connection between the hose connector element and the wiper arm body, is generally not limited and preferably corresponds to a number of two or more. In particular, a rotational strength and/or an overall stability of the snap-fit connection can be further increased by a plurality of locking elements arranged in parallel on each side of the hose connector element.

Preferably, the mounting area of the wiper arm is provided in a wiper arm head of the wiper arm, wherein the wiper arm head represents a first part of the wiper arm which is configured to be fixed to a drive shaft of the windshield wiper and which, in general, comprises a rotary joint, via which a second part of the wiper arm, namely that on which a wiper blade of the windshield wiper is arranged, is connected to the first part of the wiper arm. For example, the rotary joint is provided for folding the wiper arm away from a surface to be cleaned (e.g., for servicing the wiper, etc.) and/or for adjusting the second area of the wiper arm to a curved surface of the windshield.

To attach the hose connector element to the wiper arm body, the wiper arm body advantageously comprises an opening at least in the mounting area, on the basis of which the wiper arm body is designed to receive the hose connector element in a joining process in a joining direction that is perpendicular to the opening.

The fluid inlet of the hose connector element is configured to be connected to a first hose connecting the fluid supply system of the windshield wiper to the hose connector element while the fluid outlet is configured to be connected to a second hose which is configured to continue conveying fluid received via the first hose from the fluid supply system.

For example, the fluid supply system comprises a reservoir for a liquid, in particular a cleaning liquid such as water and/or a cleaning additive and/or another liquid. Further, the fluid supply system preferably comprises at least one pump and/or at least one valve for activating and deactivating liquid transport from the reservoir to the hose connector element.

In this respect, the wiper arm according to the invention has the particular advantage that the attachment of the hose connector element to the wiper arm body is configured to be torsion-resistant, such that interference with fluid transport, which may occur when the first hose and/or the second hose are bent or kinked in the area of the hose connector element by twisting of the hose connector element with respect to a desired mounting position on the wiper arm, which may interfere with or inhibit liquid transport through the hoses, can be prevented.

Further, the torsion-resistant assembly of the hose connector element on the wiper arm offers the advantage that, in particular if the rotation of the hose connector element changes repeatedly with respect to the wiper arm, no unwanted load will act on the first and/or the second hose, which, for example, can lead to faster wear of the hoses.

In a particularly advantageous embodiment of the present invention, the hose connector element comprises at least two flexible snap hooks, which face away from one other (i.e., outwardly) on opposite sides of the hose connector element, while the wiper arm body with the snap hooks of the hose connector element has corresponding rectangular undercuts in opposing side surfaces in the mounting area, which are designed to establish a positive locking connection with the snap hooks of the hose connector element. Such a connection formed by the snap hooks and the corresponding undercuts is also known as the “snap-fit” connection and represents the locking connection between the hose connector element and the wiper arm body described above. The positive-locking connection is preferably made if the snap hooks reach a predefined end position during the joining process in the joining direction, or reach assembly position.

Further, it is possible that the undercuts in the mounting area of the wiper arm body are configured as recesses or as through holes in the side surfaces of the wiper arm body. The latter case offers the advantage, among other things, that correct assembly of the hose connector element on the wiper arm body can be carried out in a simple manner by means of a test from the outer side of the wiper arm body, in that the correct seating of the snap hooks in the through holes in the joined state can be checked, preferably visually (by visual inspection by a person and/or automatically, e.g. by means of camera monitoring). This test can also be carried out particularly easily and/or reliably by in that the hose connector element is designed in a color that is different from the wiper arm body, so that the correct seating of the hose connector element in the through holes can additionally be checked based on the deviation in color between the two components. This explicitly does not exclude that such a color deviation between the two components can be advantageously employed in all other design variants of the hose connector element and/or the wiper arm.

In a further advantageous embodiment of the present invention, a lead-in chamfer is placed in front of each of the undercuts for inserting the respective snap hook into the respective undercut. More specifically, the lead-in chamfers are placed in front of the undercuts such that the snap hooks first pass through the lead-in chamfers before they reach the undercuts during insertion of the hose connector element into the wiper arm body in the joining direction. This simplifies the assembly of the hose connector element in the wiper arm body, as the lead-in chamfers act as a positioning aid for the snap hooks, among other things. This allows the assembly to be carried out faster and/or more reliably, for example. Preferably, a width of the lead-in chamfers substantially corresponds to a width of the snap hooks in order to ensure reliable guidance of the snap hooks in the joining direction during assembly, wherein the width of the lead-in chamfers is preferably slightly greater than the width of the snap hooks in order to ensure some clearance for easier insertion of the snap hooks into the lead-in chamfers. In addition, it is possible that a width of the lead-in chamfers will decrease in the joining direction in order to provide, on the one hand, easier insertion of the snap hooks into the lead-in chamfers and on the other hand, to provide an increasingly accurate guidance of the snap hooks before or when reaching the undercuts.

Preferably, the lead-in chamfers are configured as recesses in respective side surfaces of the wiper arm body.

Particularly preferably, the respective ends of the snap hooks which engage in the undercuts of the wiper arm body have a rectangular cross-section, so that a particularly reliable and/or clearance-free fit of the ends in the respective corresponding rectangular undercuts is achieved. This explicitly does not exclude that the ends of the snap hooks can also taper to a point in the cross section or have a shape different from this. Alternatively or additionally, a width of the ends of the snap hooks in the cross section is greater than a height of the ends of the snap hooks in the cross section, whereby a particularly reliable torsion-resistance can be achieved.

Further, it is possible that the hose connector element is formed as a single piece and/or from a plastic material and/or as a molded part, and in particular as an injection-molded part.

In a further advantageous embodiment of the present invention, the fluid inlet of the hose connector element is configured to be connected to the fluid supply system while a check valve is disposed between the fluid inlet and the fluid outlet to prevent fluid transport from the fluid outlet to the fluid inlet.

The fluid inlet and/or the fluid outlet are further advantageously configured as hose connection sleeves to enable a particularly simple connection between the hose connector element and hoses to be connected.

According to a second aspect of the present invention, a wiper is proposed for a vehicle comprising at least one wiper arm, wherein the wiper is configured to convey a wiper fluid from the hose connector element to at least one nozzle provided on the wiper arm and/or on a wiper blade of the wiper. The features, feature combinations and the resulting advantages correspond to those listed in connection with the first-mentioned aspect of the invention, in such an obvious manner that reference is made to the above statements in order to avoid repetitions.

### BRIEF DESCRIPTION OF THE DRAWINGS

In the following, exemplary embodiments of the invention are described in detail with reference to the accompanying drawings. The drawings show:

FIG. 1 a first partial view of an embodiment of a wiper arm according to the invention;

FIG. 2 a view of the hose connector element according to the invention in accordance with the embodiment;

FIG. 3 a second partial view of the embodiment of the wiper arm according to the invention;

FIG. 4 a third partial view of the embodiment of the wiper arm according to the invention;

FIG. 5 a fourth partial view of the embodiment of the wiper arm according to the invention;

FIG. 6 a further view of the hose connector element according to the invention in accordance with the embodiment; and

FIG. 7 a schematic view of an embodiment of a windshield wiper according to the invention.

### DETAILED DESCRIPTION

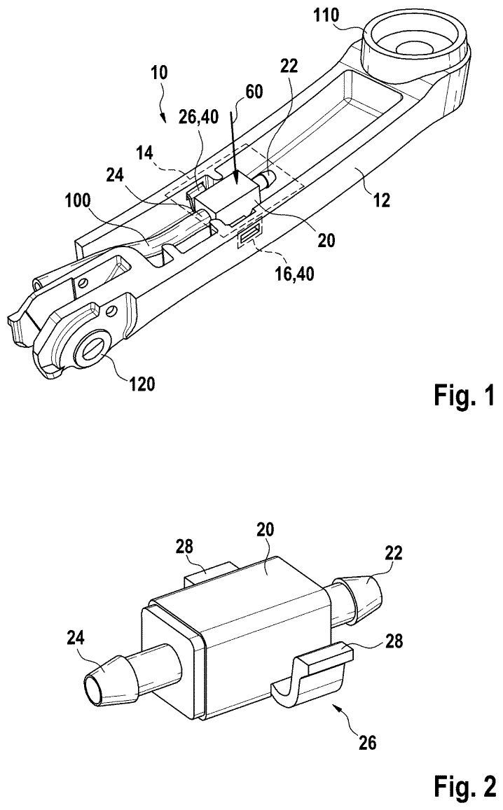

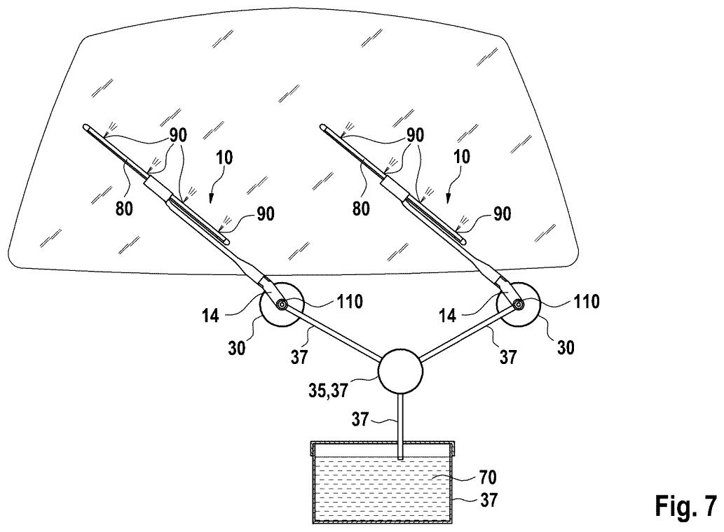

FIG. 1 shows a first partial view of an embodiment of a wiper arm 10 according to the present invention, which comprises a wiper arm body 12 having a mounting area 14 for a hose connector element 20, wherein the part of the wiper arm 10 shown here represents a wiper arm head, which includes a mounting area 110 for attaching the wiper arm 10 to a shaft (not shown) of a windshield wiper drive (not shown) and a component of a pivot joint 120, on which a further part of the wiper arm 10 not shown here can be arranged in such a manner that it can rotate, wherein a wiper blade 80 (see FIG. 7) can in turn be arranged on the further part of the wiper arm 10.

Furthermore, the wiper arm 10 comprises a hose connector element 20 having a fluid inlet 22 and a fluid outlet 24, wherein the hose connector element 20 is configured to connect to a fluid supply system 35 (see FIG. 7) by means of the fluid inlet 22 and the fluid outlet 24, which are each configured as a hose connector sleeve here, in such a way that it can transport fluid and is fixed to the mounting area 14 of the wiper arm body 12 by means of a snap-fit connection 40 in a torsion-resistant manner.

The snap-fit connection 40 is here realized by respective rectangular undercuts 16 formed as through holes in opposite side surfaces of the wiper arm body 12 and by flexible snap hooks 26 corresponding to the undercuts 16, which are provided on the hose connector element 20.

During a mounting process, the hose connector element 20 is inserted into the wiper arm body 12 in a joining direction 60 until the snap hooks 26 reach the undercuts 16 and engage the undercuts 16 due to the flexible design of the snap hooks 26, such that a positive-locking connection is made between the hose connector element 20 and the wiper arm body 12.

Furthermore, FIG. 1 shows a hose 100 that is disposed on the hose connection sleeve of the fluid outlet 24 in a friction-locking manner to transport a wiper fluid (see FIG. 7) provided via the fluid inlet 22 to one or more nozzles 90 (see FIG. 7). A further hose coming in from the fluid supply system 35 is not shown here.

FIG. 2 shows a view of the hose connector element 20 according to the invention in accordance with the embodiment shown in FIG. 1.

FIG. 2 shows that respective ends 28 of the snap hooks 26 of the hose connector element 20 each have a rectangular cross-section, wherein a length and a width of respective end surfaces of the snap hooks 26 correspond to a length and a width of an opening area of the undercuts 16 of the wiper arm body 12 configured as rectangular through holes in order to achieve the torsion-resistance according to the invention in the mounted state.

Advantageously, the hose connector element 20 has an integrated (not shown) check valve to prevent fluid transport from the fluid outlet 24 to the fluid inlet 22.

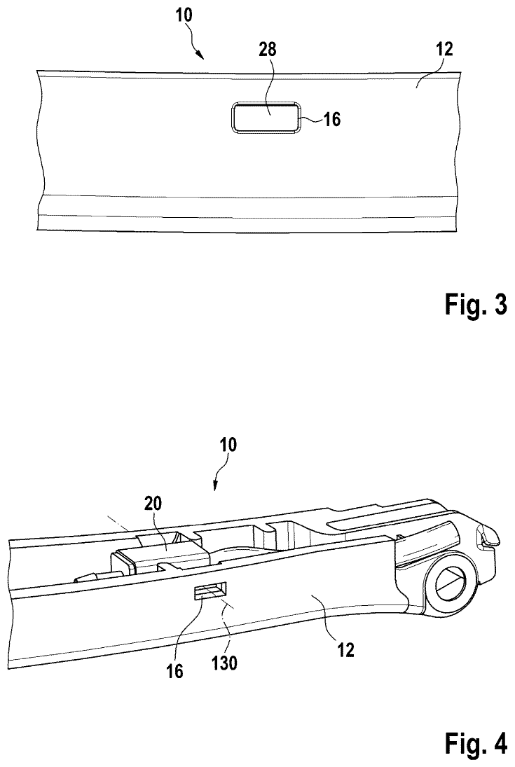

FIG. 3 shows a second partial view of the embodiment of the wiper arm 10 according to the invention, and in particular a partial view of a side surface of the wiper arm body 12, into the undercut 16 of which the snap hook 28 is inserted as described above.

Because the undercut 16 is formed as a through hole, it is possible to easily check the correct joining state between the hose connector element 20 and the wiper arm body 12.

FIG. 4 shows a third partial view of the embodiment of the wiper arm 10 according to the invention in which an axis 130 is shown for comparison, around which the hose connector element 20 can potentially rotate using the “snap-fit-pins” used in the prior art for connecting the hose connector element 20 and the wiper arm body 12.

With regard to the further description of the figure, reference is made to the above descriptions of the figures in order to avoid repetitions.

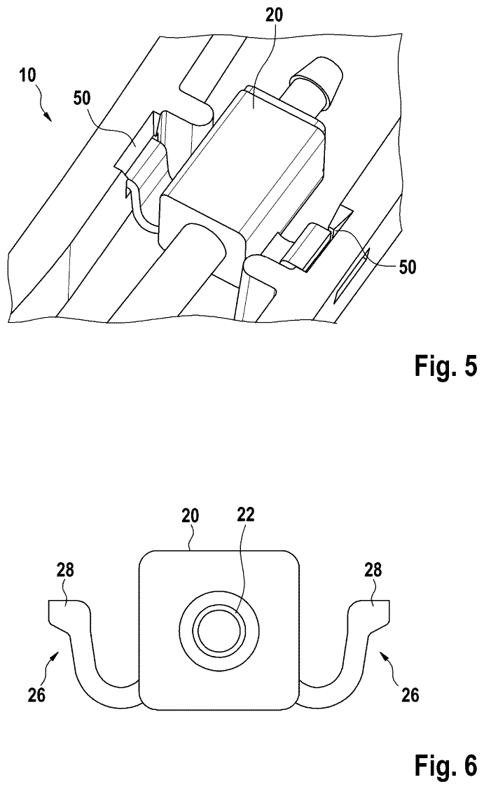

FIG. 5 shows a fourth partial view of the embodiment of the wiper arm 10 according to the invention, wherein in FIG. 5 in particular lead-in chamfers 50 provided on the side surfaces of the wiper arm body 12 are visible, which are arranged before the undercuts 16 (see above descriptions of the figures) in order to provide improved guidance of the hose connector element 20 while it is being mounted on the wiper arm body 12.

FIG. 6 shows a further view of the hose connector element 20 according to the invention in accordance with the embodiment in a top view of the fluid inlet 22 to illustrate an exemplary embodiment of the ends 28 of the snap hooks 26.

FIG. 7 shows a schematic view of an embodiment of a windshield wiper according to the invention for a front windshield 140 of a vehicle configured as a passenger car, wherein the windshield wiper comprises two wiper arms 10 according to the invention with respective wiper blades 80. The wiper arms 10 are connected via respective mounting sections 110 to shafts of respective drives 30 of the windshield wiper, and on this basis are designed to be moved via the drives 30 over the windshield 140.

The wiper blades 80 each have a plurality of nozzles 90 from which a wiper fluid 70 provided by a fluid supply system 35 of the vehicle may be dispensed to clean the windshield 140. For this purpose, the fluid supply system 35 has at least one pump 37, which is configured to transport the wiper fluid 70 to the nozzles 90 via respective fluid connections and via the hose connector element 20 described above (not shown here). The hose connector element 20 is disposed here in a mounting area 14 on a vehicle-facing side of the wiper arms 10.

1. A wiper arm (10) of a windshield wiper comprising:
a wiper arm body (12) having a mounting area (14) for a hose connector element (20), and
a hose connector element (20) having a fluid inlet (22) and a fluid outlet (24), wherein
the wiper arm body (12) is configured to connect to a drive (30), and
the hose connector element (20) is configured to connect to a fluid supply system (35) by the fluid inlet (22) and the fluid outlet (24) to transport fluid and is attached to the mounting area (14) of the wiper arm body (12) in a torsion-resistant manner by a snap-fit connection (40).

2. The wiper arm (10) according to claim 1, wherein
the hose connector element (20) comprises at least two flexible snap hooks (26) arranged on opposite sides of the hose connector element (20) facing away from one other,
the wiper arm body (12) has rectangular undercuts (16) corresponding with the snap hooks (26) of the hose connector element (20) in opposite side surfaces in the mounting area (14) which are configured to establish a positive-locking connection with the snap hooks (26) of the hose connector element (20).

3. The wiper arm (10) according to claim 2, wherein the undercuts (16) are formed in the mounting area (14) of the wiper arm body (12) as recesses or as through holes in the side surfaces of the wiper arm body (12).

4. The wiper arm (10) according to claim 2, wherein the undercuts (16) are each located adjacent a lead-in chamfer (50) for inserting the respective snap hook (26) into the respective undercut (16).

5. The wiper arm (10) according to claim 4, wherein the lead-in chamfers (50) are formed as recesses in respective side surfaces of the wiper arm body (12).

6. The wiper arm (10) according to claim 2, wherein
respective ends (28) of the snap hooks (26) engaging the undercuts (16) of the wiper arm body (12) have a rectangular cross-section, and/or
a width of the ends (28) of the snap hooks (26) is larger in cross-section than a height of the ends (28) of the snap hooks (26) in cross-section.

7. The wiper arm (10) according to claim 1, wherein the hose connector element (20) is
one piece, and/or
made from a plastic material, and/or
made as a molded part.

8. The wiper arm (10) according to claim 1, wherein the fluid inlet (22) of the hose connector element (20) is configured to connect to the fluid supply system (35), and wherein a check valve is disposed between the fluid inlet (22) and the fluid outlet (24) to prevent fluid transport from the fluid outlet (24) to the fluid inlet (22).

9. The wiper arm (10) according to claim 1, wherein the fluid inlet (22) and/or the fluid outlet (24) are formed as hose connection sleeves.

10. A windshield wiper for a vehicle comprising at least one wiper arm (10) according to claim 1, wherein the windshield wiper is configured to convey a wiper fluid (70) from the hose connector element (20) to at least one nozzle (90) provided on the wiper arm (10) and/or on a wiper blade (80).

11. The wiper arm (10) according to claim 3, wherein the undercuts (16) are each located adjacent a lead-in chamfer (50) for inserting the respective snap hook (26) into the respective undercut (16).

12. The wiper arm (10) according to claim 7, wherein the hose connector element (20) is an injection-molded part.
